(19) United States
(12) Patent Application Publication
(10) Pub. No.: US 2006/0284860 A1
(43) Pub. Date: Dec. 21, 2006

(54) Display device and method for recovering from abnormal power-on therefor

(75) Inventors: Chien-Ken Chang, Taoyuan Hsien (TW); Jung-Yi Yang, Taoyuan Hsien (TW); Bao-Kim Liu, Taoyuan Hsien (TW)

Correspondence Address: LADAS & PARRY, 26 WEST 61ST STREET, NEW YORK, NY, 10023, US

(73) Assignee: DELTA ELECTRONICS, INC.

(21) Appl. No.: 11/235,891

(22) Filed: Sep. 27, 2005

(30) Foreign Application Priority Data
Jun. 16, 2005 (TW) 094120021

(51) Int. Cl. G09G 5/00

(52) U.S. Cl. 345/204

(57) ABSTRACT

A display device includes a driving unit and a processing unit. If the driving unit operates abnormally during a power-on period, the processing unit generates a control signal according to a driving signal outputted by the driving unit. In response to the control signal, the driving unit is reset and then re-outputs the driving signal. A method for recovering from abnormal power-on therefor includes generating two signals, wherein one signal is adapted for re-activating a light source and the other is adapted for resetting the driving unit so that the driving unit may re-output the driving signal.

### CROSS-REFERENCES TO RELATED APPLICATIONS

This application claims priority to Taiwan Patent Application No. 094120021 filed on Jun. 16, 2005.

### BACKGROUND OF THE INVENTION

1. Field of the Invention

The present invention relates to a display device and a method for recovering from abnormal power-on therefor, and more specifically, relates to a projection display and a method for recovering from abnormal power-on therefor.

2. Descriptions of the Related Art

Since projection display techniques are mature nowadays, many of the projection displays in the current market are capable of receiving computer signals (such as analog RGB or DVI signals), general video signals (AV signals) and/or television signals (RF signals) individually or simultaneously, and converting one of them to generate an image for display. Taking a projection display capable of simultaneously receiving analog RGB, DVI, AV and RF signals as an example, the projection display generally includes a front-end signal processing circuit which comprises an ADC (analog-to-digital converter) for processing the analog RGB signals, a digital differential signal receiver for processing the DVI signals, a video decoder for processing the AV signals, and a television tuner for demodulating the RF signals. The front-end signal processing circuit further comprises a multiplexer and a video scaling processor. The multiplexer is used to select one of the processed analog RGB, DVI, AV and RF signals as a display signal. The video scaling processor is used to adjust a resolution and/or a display frequency of the display signal and output a front-end signal.

FIG. 1 shows the aforementioned projection display, in which the front-end signal processing circuit is not shown. As shown in FIG. 1, the projection display 11 further comprises a driving unit 101, a display unit 103, an activation unit 105, a light source 107 and a processing unit 111, wherein the activation unit 105 is a ballast and the light source 107 is a projection lamp. When the projection display 11 is powered on, the driving unit 101 receives the front-end signal 100 from the front-end signal processing circuit. According to the front-end signal 100, the driving unit 101 outputs a first signal 102 to drive the display unit 103, and outputs a second signal 104 to drive the activation unit 105. The display unit 103 may be a DMD (Digital Micromirror Device), an LCD device or other display devices for projection. According to the first signal 102, the display unit 103 generates an image. After receiving the second signal 104, the activation unit 105 transmits a third signal 106 to activate the light source 107. The activated light source 107 then emits lights to project the image generated by the display unit 103 onto a screen 109.

After the driving unit 101 transmits the first signal 102 to the display unit 103, the processing unit 111 retrieves a fourth signal 108 from the driving unit 101. The fourth signal 108 represents the operation status of the driving unit 101. After transmitting the third signal 106 to the light source 107, the activation unit 105 outputs a fifth signal 110 to the processing unit 111, which tells whether the light source 107 is activated successfully or not.

While the activation unit 105 transmits the third signal 106 to the light source 107 to activate the light source 107, it requires a very high activation voltage, e.g., 2 or 3 KV. Peripheral circuits like the driving unit 101 might be interfered by such a high voltage at the moment of activating the light source 107. The interference causes the display function of the projection display 11 abnormal or even crashing. Once either the driving unit 101 or the light source 107 cannot operate properly, the processing unit 111 is aware of this situation by receiving the fourth signal 108 and the fifth signal 110. The processing unit 111 then outputs a sixth signal 112 to the driving unit 101. In response to the sixth signal 112, the driving unit 101 is reset and re-outputs the first signal 102 and the second signal 104 to re-display the image and re-activate the light source 107, respectively.

However, re-activating the light source 107 may cause another high voltage interference; hence another abnormal situation occurs to the peripheral circuits again. In fact, re-activating the light source 107 is a redundant step especially when the driving unit 101 is abnormal but the light source 107 has been activated normally. Furthermore, the processing unit 111 may not get the exact status of the driving unit 101 if the driving unit 101 is interfered by a high voltage too badly to deliver the fourth signal 108 correctly. Therefore, how to recover the operations of projection displays from abnormal power-on is still waiting for a solution.

### SUMMARY OF THE INVENTION

An object of the present invention is to provide a display device comprising a driving unit, a light source and a processing unit. The driving unit is configured to output a driving signal to display an image. The light source is configured to project the image onto a screen after activation. The processing unit is configured to determine whether the driving unit operates normally according to the driving signal. If the driving unit operates abnormally, the processing unit outputs a first control signal to the driving unit. In response to the first signal, the driving unit re-outputs the driving signal to display the image. In this circumstance, the light source does not have to be re-activated. Since the operation of the driving unit can be determined correctly and redundant operations for re-activating the light source are not executed, the stability of the display device during a power-on period is enhanced.

The display device further comprises an activation unit for activating the light source. After the display device is powered on, the activation unit outputs a second control signal to the processing unit according to an activation status of the light source. The processing unit determines whether the activation status is normal according to the second control signal. If the activation status of the light source is abnormal, the processing unit outputs a third control signal to the driving unit. The driving unit outputs a fourth control signal to the activation unit in response to the third control signal. The activation unit re-activates the light source in response to the fourth control signal.

Another object of the present invention is to provide a method for recovering from an abnormal power-on status of a display device. The display device comprises a driving unit to output a driving signal to display an image. The method includes the following steps: determining whether the driving unit operates normally according to the driving signal; generating a first signal if the driving unit operates abnormally; and re-outputting the driving signal to display an image in response to the first signal. Since the operation of the driving unit can be determined correctly and redundant operations for re-activating the light source are not executed, the display device may return stable rapidly.

The method further comprises the following steps: determining whether an activation status of the light source is normal; generating a second signal if the activation status is abnormal; and re-activating the light source in response to the second signal.

A further object of the present invention is to provide a method for recovering from an abnormal power-on status of a display device. The display device comprises a light source and a driving unit. The driving unit is configured to output a driving signal to display an image. The method includes the following steps: determining whether an activation status of the light source is normal; if not, generating a first signal; re-activating the light source in response to the first signal; determining whether the driving unit operates normally according to the driving signal; if not, generating a second signal; and re-outputting the driving signal to display the image in response to the second signal.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of a projection display of the prior art;

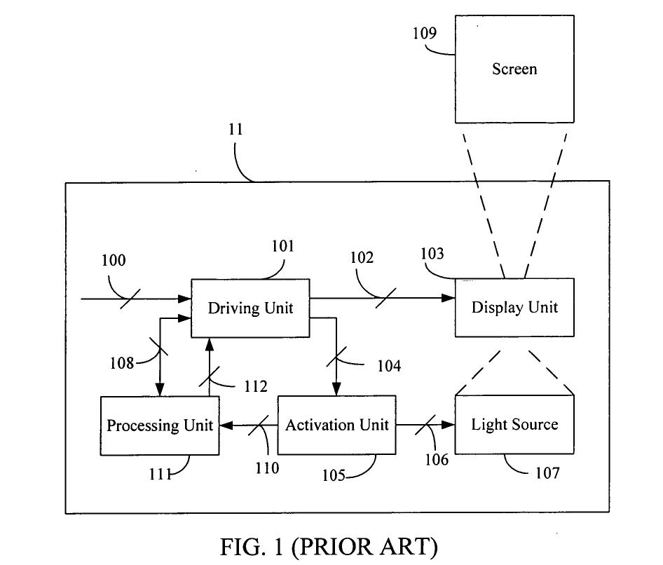

FIG. 2 is a schematic diagram of an embodiment of the present invention;

FIG. 3 is a schematic diagram of a processing unit of the embodiment;

FIG. 4 is a flow chart of a method according to the present invention;

FIG. 5 is a further flow chart of the method; and

FIG. 6 is a flow chart of another method according to the present invention.

### DESCRIPTION OF THE PREFERRED EMBODIMENT

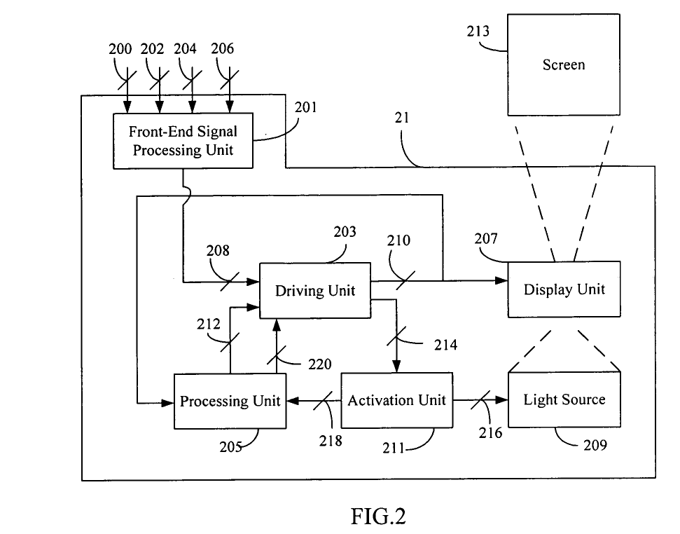

FIG. 2 shows one embodiment of the present invention, which is a projection display 21. The projection display 21 can simultaneously receive an analog RGB signal 200, a DVI signal 202, an AV signal 204 and an RF signal 206, and select one of these signals to display an image after processing. The projection display 21 comprises a front-end signal processing unit 201, a driving unit 203 and a processing unit 205. When the projection display 21 is powered on, the front-end signal processing unit 201 selects one of the analog RGB signal 200, the DVI signal 202, the AV signal 204 and the RF signal 206, and outputs a front-end signal 208 after adjusting a resolution and a display frequency. When receiving the front-end signal 208, the driving unit 203 outputs a driving signal 210 to display the image. The driving signal 210 is transmitted to the processing unit 205 as well. The processing unit 205 determines whether the driving unit 203 operates normally according to the driving signal 210. If the driving unit 203 operates abnormally, the processing unit 205 outputs a first control signal 212 to the driving unit 203. In response to the first control signal 212, the driving unit 203 is reset and then re-outputs the driving signal 210 to display the image.

The projection display 21 further comprises a display unit 207, a light source 209 and an activation unit 211. After receiving the driving signal 210, the display unit 207 converts from the driving signal 210 to the image. While the projection display 21 is powered on, the driving unit 203 also transmits a signal 214 to the activation unit 211. The activation unit 211 transmits a signal 216 to the light source 209 to activate the light source 209 in response to the signal 214. The activated light source 209 projects the image generated by the display unit 207 to a screen 213 if the activation is successful.

The activation unit 211 can output a second control signal 218 to the processing unit 205 according to the activation status of the light source 209. According to the second control signal 218, the processing unit 205 determines whether the activation status of the light source 209 is normal. If the activation status is abnormal, the processing unit 205 outputs a third control signal 220 to the driving unit 203 in order to inform the driving unit 203 that the activation status of the light source 209 is abnormal. The driving unit 203 hence re-outputs the signal 214, i.e., a fourth control signal to the activation unit 211 in response to the third control signal 220. The activation unit 211 then re-activates the light source 209 in response to the signal 214.

According to the above description, the embodiment determines whether the driving unit 203 operates normally according to the driving signal 210. Therefore, even if the driving unit 203 abnormally shuts down or is unable to output any signal for some reason, such as a high voltage interference while the light source 209 is being activated, the processing unit 205 still can determine the abnormal status of the driving unit 203 based on the abnormal driving signal 210 and then transmit the first control signal 212 to reset the driving unit 203. Furthermore, the embodiment uses the third control signal 220 to inform the driving unit 203 that the activation status of the light source 209 is abnormal and to request re-activating the light source 209. In other words, the first control signal 212 and the third control signal 220 are used to show the abnormal status of the driving unit 203 and the light source 209, respectively, in order to either execute a reset operation or execute re-activation operation. Accordingly, unnecessary recovery operations are not executed.

Because a high voltage interference generated by re-activating the light source 209 may impact the operation of the driving unit 203 again, the driving unit 203 may be reset and re-output the driving signal 210 to the display unit 207 to display the image in response to the third control signal 220.

If the driving signal 210 comprises a clock signal at any frequency, such as 40 MHz, the processing unit 205 can determine whether the driving unit 203 operates normally according to a voltage of the clock signal during a particular time period, e.g., one cycle. More specifically, if the voltage of the clock signal maintains unchanged in one cycle, it represents that the driving unit 203 operates abnormally.

If the driving signal 210 comprises a synchronous signal at any frequency, such as 30 KHz, the processing unit 205 can determine whether the driving unit 203 operates normally according to a voltage of the synchronous signal during a particular time period, e.g., one cycle. More specifically, if the voltage of the synchronous signal maintains unchanged in one cycle, it represents that the driving unit 203 operates abnormally.

If the driving signal 210 comprises a color signal, the processing unit 205 can determine whether the driving unit 203 operates normally according to the color signal. For example, the color signal of the projection display 21 is an 8-bit digital signal for each of the red, green, blue fundamental colors. While the projection display 21 is powered on, the front-end signal processing unit 201 is commanded to output a full blue frame, and therefore the eight bits BIT0-BIT7 of the blue color signal are all ‘1’ if the driving unit 203 operates normally. After the display unit 207 receives the color signal, the displayed image is a blue frame. If the driving unit 203 operates abnormally, errors occur to BIT0-BIT7, e.g., not all of the bits are ‘1’ or even there is no digital level. The processing unit 205 can determine whether the driving unit 203 operates normally by detecting whether one bit, such as BIT7, or some bits, such as BIT5 to BIT7, of the color signal are normal.

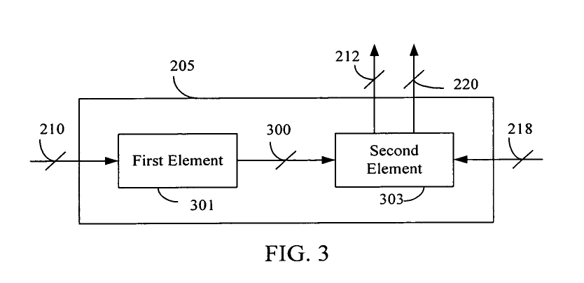

FIG. 3 shows the processing unit 205. As shown in FIG. 3, the processing unit 205 comprises a first element 301 and a second element 303. The first element 301 is configured to detect whether the driving unit 203 operates normally according to the driving signal 210 and to output a status signal 300 according to a detection result. After receiving the status signal 300, the second element 303 outputs the first control signal 212 to the driving unit 203 to reset the driving unit 203 if the driving unit 203 is determined abnormal. The first element 301 and the second element 303 can be integrated in one device, e.g. in one chip, or be arranged in different devices, e.g. in two chips.

The projection display 21 may be a front projection display such as a DMD, an LCD or other types of projector. However, the present invention dose not limit to the front projection device, it may also be applied to a rear projection display which comprises a projection display 21, a screen 213, and a cabinet (not shown) in which both of the projection display 21 and the screen 213 are well embedded. Furthermore, the above-mentioned signals can be transmitted via an I²C command.

The present invention also provides a method for recovering from an abnormal power-on status of a display device. The method does not perform redundant operations for re-activating a light source when it is activated normally so the display device may return stable rapidly.

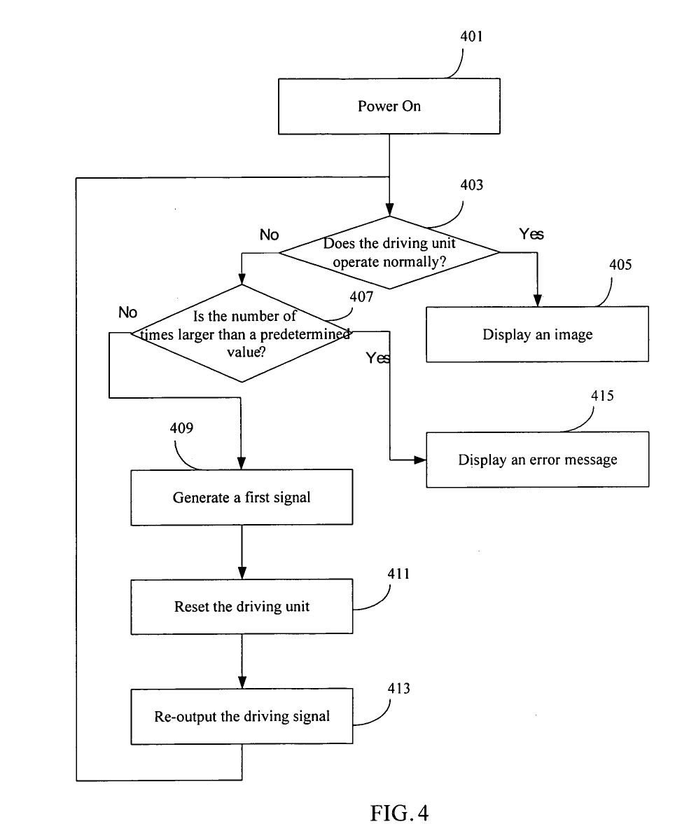

An example of the display device is a projection display comprising a driving unit and a processing unit. The driving unit is configured to output a driving signal to display an image. The processing unit is configured to control operations of the driving unit and other units. FIG. 4 shows a flow chart of the method. When step 401 is executed, the projection display is powered on. When step 403 is executed, the processing unit determines whether the driving unit operates normally according to the driving signal outputted by the driving unit. If yes, step 405 is executed to display the image. If not, step 407 is executed to determine whether the number of times of resetting the driving unit is larger than a predetermined value. If the number of times of resetting the driving unit is not larger than the predetermined value, e.g., it is the first time to reset the driving unit and the predetermined value is 3, step 409 is executed. The processing unit generates a first signal which is then transmitted to the driving unit. Step 411 is then executed. The driving unit is reset in response to the first signal. After that, step 413 is executed. The driving unit re-outputs the driving signal to display the image.

Then the method returns to step 403. The processing unit determines whether the driving unit operates normally according to the driving signal re-outputted by the driving unit. Steps 403, 407, 409, 411, and 413 are repeated in such a manner until the number of times of resetting the driving unit is determined larger than the predetermined value in step 407. Step 415 is thereupon executed to display an error message which may be a light-up of a light bulb or an LED on the panel of the projection display requested by the processing unit to inform users that the projection display malfunctions and cannot be powered on normally.

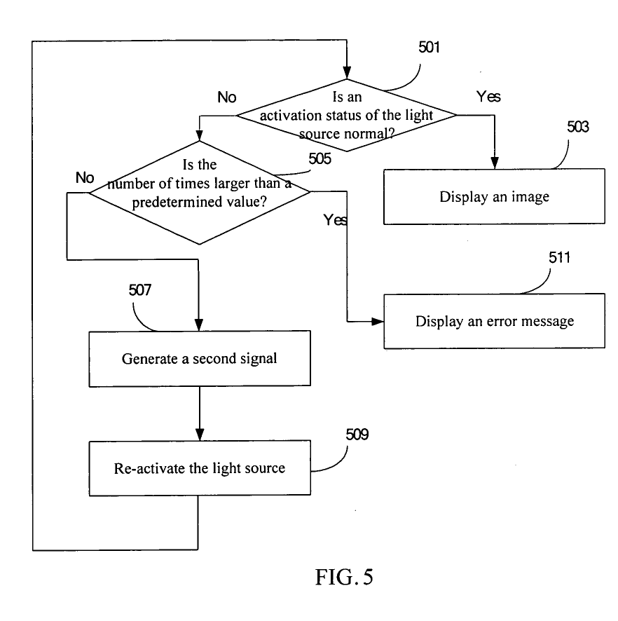

The method also comprises further recovery steps for an abnormal activation status of a light source during a power-on period as FIG. 5 shows. When step 501 is executed, the processing unit determines whether an activation status of the light source is normal. If yes, step 503 is executed and the projection display displays the image. If not, step 505 is executed in which the processing unit determines whether the number of times of re-activating the light source is larger than a predetermined value. If not, e.g., it is the first time to re-activate the light source after the power-on and the predetermined value is 3, then step 507 is executed in which the processing unit generates a second signal. In response to the second signal, step 509 is executed to re-activate the light source. During re-activation, the light source may be cooled down for a predetermined period of time, such as 30 seconds, so the temperature of the light source may decline. This prevents the light source from damage resulting from that the time intervals between two sequential activations are too close.

The method now returns to step 501. The processing unit determines whether the activation status of the light source is normal. Steps 501, 505, 507, and 509 are repeated in such a manner until the number of times of re-activating the light source is determined larger than the predetermined value in step 505. Step 511 is then executed to display an error message which may be a light-up of a light bulb or an LED on the panel of the projection display requested by the processing unit to inform users that the projection display malfunctions and cannot be powered on normally.

The method may comprise a step, after step 507 is executed, that the driving unit is reset and re-outputs the driving signal in response to the second signal to display the image. This step avoid that a high voltage interference resulting from the re-activation of the light source influences the driving unit which originally operates normally. Therefore, this step makes the driving unit recover after interfered by the high voltage.

If the driving signal comprises a clock signal at any frequency, step 403 further comprises the step of determining whether a voltage of the clock signal performs normally during a particular time period. In other words, the processing unit can determine whether the driving unit operates normally according to the voltage of the clock signal in a particular time period.

If the driving signal comprises a synchronous signal at any frequency, step 403 further comprises the step of determining whether a voltage of the synchronous signal performs normally during a particular time period. In other words, the processing unit can determine whether the driving unit operates normally according to the voltage of the synchronous signal in a particular time period.

If the driving signal comprises a color signal, step 403 further comprises the step of determining whether the color signal performs normally. In other words, the processing unit can determine whether the driving unit operates normally according to the color signal.

Although the above method comprises step 407 and step 505, the present invention does not limit that determining whether the number of times of resetting the driving unit or re-activating the light source is larger than a predetermined value is a necessary step. Besides, the present invention does not limit the execution timing of step 501.

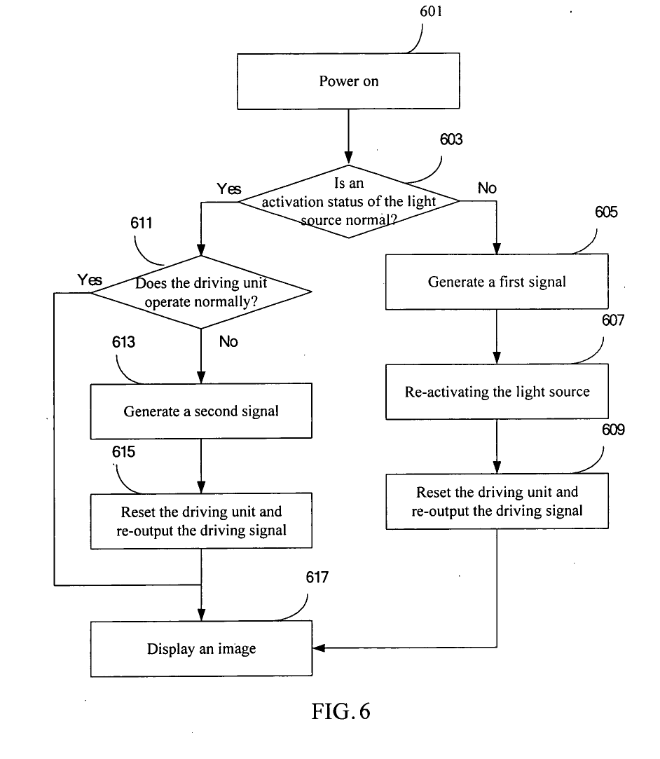

The present invention also provides another method for recovering from an abnormal power-on status of a projection display. The projection display comprises a driving unit, a light source, a processing unit and an activation unit. The driving unit is configured to output a driving signal to display an image. The light source is configured to project the image onto a screen. The processing unit is configured to control operations of the driving unit and other units. The activation unit is configured to activate the light source. The method is shown in FIG. 6. When step 601 is executed, the projection display is powered on. Step 603 is then executed. The processing unit determines whether an activation status of the light source is normal. If not, step 605 is executed in which the processing unit generates a first signal to the driving unit to request re-activating the light source. Step 607 is then executed in which the driving unit requests the activation unit to re-activate the light source in response to the first signal. The light source is hence re-activated. In order to prevent the driving unit from an interference caused from a high voltage due to re-activating the light source, the method further comprises step 609, after step 607 is executed, to reset the driving unit so the driving unit may re-outputs the driving signal in response to the first signal.

In step 603, if the processing unit determines that the activation status of the light source is normal, step 611 is executed in which the processing unit determines whether the driving unit operates normally according to the driving signal. If not, step 613 is executed in which the processing unit generates a second signal. Then step 615 is executed in which the driving unit is reset to re-output the driving signal in response to the second signal.

If the processing unit determines that the driving unit operates normally in step 611, then step 617 is executed in which the projection display displays the image. Furthermore, step 617 is also executed, after step 609 and step 615 are executed, to display the image.

As described above, if the driving signal comprises a clock signal or a synchronous signal, the processing unit may determine whether the driving unit operates normally by detecting whether a voltage of the clock signal or the synchronous signal is normal in a particular time period when step 611 is executed. If the driving signal comprises a color signal, the processing unit may determine whether the driving unit operates normally by detecting whether the color signal is normal when step 611 is executed.

Those skilled in the art may realize, based on the above description, that the method shown in FIG. 6 selectively outputs one of the two signals, the first signal and the second signal, to avoid redundant operations for re-activating the light source if the light source has been activated normally. This helps projection displays recover from abnormal power-on rapidly.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A display device comprising:
a driving unit for outputting a driving signal to display an image; and
a processing unit for determining whether the driving unit operates normally according to the driving signal, the processing unit outputting a first control signal to the driving unit if the driving unit operates abnormally;
wherein the driving unit re-outputs the driving signal to display the image in response to the first control signal.

2. The display device of claim 1, further comprising:
a light source; and
an activation unit for activating the light source;
wherein the activation unit outputs a second control signal to the processing unit according to an activation status of the light source, the processing unit determines whether the light source operates normally according to the second control signal, the processing unit outputs a third control signal to the driving unit if the light source operates abnormally, the driving unit outputs a fourth control signal to the activation unit in response to the third control signal, and the activation unit re-activates the light source in response to the fourth control signal.

3. The display device of claim 2, wherein the driving unit re-outputs the driving signal to display the image in response to the third control signal.

4. The display device of claim 1, wherein the driving signal comprises a clock signal and the processing unit determines whether the driving unit operates normally according to a voltage of the clock signal in a particular time period.

5. The display device of claim 1, wherein the driving signal comprises a synchronous signal and the processing unit determines whether the driving unit operates normally according to a voltage of the synchronous signal in a particular time period.

6. The display device of claim 1, wherein the processing unit comprises:
a first element for detecting whether the driving unit operates normally according to the driving signal and outputting a status signal; and
a second element for receiving the status signal, the second element outputting the first control signal to the driving unit if the driving unit operates abnormally.

7. The display device of claim 1, wherein the driving signal comprises a color signal and the processing unit determines whether the driving unit operates normally according to the color signal.

8. The display device of claim 7, wherein the image, responsive to the color signal, is a blue frame if the driving unit operates normally.

9. The display device of claim 1, wherein the display device is a projection display.

10. A method for recovering from an abnormal power-on status of a display device, the display device comprising a driving unit for outputting a driving signal to display an image, the method comprising:
determining whether the driving unit operates normally according to the driving signal;
generating a first signal if the driving unit operates abnormally; and
re-outputting the driving signal to display the image in response to the first signal.

11. The method of claim 10, the display device further comprising a light source, the method further comprising:
determining whether an activation status of the light source is normal;
generating a second signal if the activation status is abnormal; and
re-activating the light source in response to the second signal.

12. The method of claim 11, further comprising: re-outputting the driving signal to display the image in response to the second signal.

13. The method of claim 10, wherein the driving signal comprises a clock signal and the determining step comprises: determining whether a voltage of the clock signal performs normally in a particular time period.

14. The method of claim 10, wherein the driving signal comprises a synchronous signal and the determining step comprises: determining whether a voltage of the synchronous signal performs normally in a particular time period.

15. The method of claim 10, wherein the driving signal comprises a color signal and the determining step comprises: determining whether the color signal performs normally.

16. A method for recovering from an abnormal power-on status of a display device, the display device comprising a light source and a driving unit, the driving unit being configured to output a driving signal to display an image, the method comprising:
(a) determining whether an activation status of the light source is normal, if not, going to steps (b) and (c), if yes, going to step (d);
(b) generating a first signal;
(c) re-activating the light source in response to the first signal;
(d) determining whether the driving unit operates normally according to the driving signal, if not, going to steps (e) and (f);
(e) generating a second signal; and
(f) re-outputting the driving signal to display the image in response to the second signal.

17. The method of claim 16, further comprising: (g) re-outputting the driving signal to display the image in response to the first signal.

18. The method of claim 16, wherein the driving signal comprises a clock signal and step (d) comprises: (h) determining whether a voltage of the clock signal performs normally in a particular time period.

19. The method of claim 16, wherein the driving signal comprises a synchronous signal and step (d) comprises: (i) determining whether a voltage of the synchronous signal performs normally in a particular time period.

20. The method of claim 16, wherein the driving signal comprises a color signal and step (d) comprises: (j) determining whether the color signal performs normally.
